(19) United States
(12) Patent Application Publication
(10) Pub. No.: US 2015/0122093 A1
(43) Pub. Date: May 7, 2015

(54) MICROTOME AND METHOD FOR CONTROLLING A SAFETY DEVICE OF A MICROTOME

(71) Applicant: MICROM INTERNATIONAL GMBH, Walldorf (DE)

(72) Inventor: Roland Johe, Eberbach (DE)

(21) Appl. No.: 14/401,314

(22) PCT Filed: Apr. 4, 2013
(86) PCT No.: PCT/EP2013/000998

§ 371 Date: Nov. 14, 2014

(30) Foreign Application Priority Data
May 25, 2012 (DE) 10 2012 010 275.5

(51) Int. Cl. G01N 1/06

(52) U.S. Cl. CPC G01N 1/06
USPC 83/13; 83/72

(57) ABSTRACT

A microtome has a knife and a specimen holder for a specimen. The specimen holder can be adjusted relative to the knife. A safety device for the knife is provided, which is adjustable between a protective position, in which it covers the knife at least partially, and a release position, in which it releases the knife. Status parameters of the microtome are detected by means of a sensor and analyzed in a control device. A driving device, by means of which the safety device can be brought at least from the release position into the protective position, is associated with the safety device. The driving device can be actuated by the control device as a function of at least one status parameter of the microtome.

### CROSS REFERENCE TO RELATED APPLICATIONS

This application is a United States National Phase Application of International Application PCT/EP2013/000998 filed Apr. 4, 2013 and claims the benefit of priority under 35 U.S.C. §119 of German Patent Application DE 10 2012 010 275.5 filed May 25, 2012, the entire contents of which are incorporated herein by reference.

### FIELD OF THE INVENTION

The present invention pertains to a microtome with a blade and with a specimen holder for a specimen, wherein the specimen holder is adjustable relative to the blade, and with a safety device for the blade, which is adjustable between a protective position, in which it covers the blade at least partially, and a release position, in which it releases the blade, wherein status parameters of the microtome can be detected by means of at least one sensor and analyzed in a control device. In addition, the present invention pertains to a method for controlling a safety device of a blade of a corresponding microtome.

### BACKGROUND OF THE INVENTION

A microtome is a cutting device, with which a thin layer can be cut off or shaved off from a specimen, for example, a tissue specimen, by means of a very sharp blade, and this layer can then be subjected to further processing and later to microscopic examination. After preparing one or more section preparations, the tissue specimen is removed and replaced by a new tissue specimen. When inserting and removing the tissue specimen, there is a risk that the user will cut himself with the very sharp knife. To avoid this, a pivotable safety strap, which can be brought by the user manually into a protective position, in which it covers the blade of the knife, is usually provided in a microtome. However, the user often neglects this out of laziness or due to lack of time, and relatively many cutting injuries to the user do therefore occur.

### SUMMARY OF THE INVENTION

A basic object of the present invention is to create a microtome, in which the risk of injury to the user is reduced. In addition, a method shall be created for controlling a safety device of a knife or a microtome, which can be carried out in a simple manner and with which the risk of injury to the user is reduced.

This object is accomplished with respect to the microtome by the features according to the invention, with which provisions are made for a driving device, by means of which the safety device can be brought at least from the release position into the protective position, to be associated with the safety device. A driving device can be actuated by a control device as a function of at least one status parameter of the microtome.

The underlying rationale is to monitor or detect the operating state of the microtome by detecting one or more status parameters of the microtome. The corresponding data are fed to an analyzing device or the control device, and, depending on the status parameters, the safety device is either brought into the protective position, in which it covers the knife and in which the user is protected from cuts, or it remains in the release position, in which the specimen can be cut.

The safety device is preferably a strap, which is known per se, and which can be placed over a blade of the knife. The strap may be mounted displaceably or especially pivotably.

When the control device determines that the safety device is to be brought into the protective position based on the current status parameter of the microtome, the driving device, which brings about the motion or adjustment of the safety device, is activated. The driving device may be an electric motor, an electromagnetic drive or even a spring. When an electric motor or an electromagnetic drive is used, the safety device can be adjusted between the protective position and the release position as desired.

When a spring is used, provisions may be made, in particular, for maintaining the safety device under spring preloading in the release position, but for preventing the safety device from being adjusted into the protective position by at least one stop. The stop can be lifted or released by means of the control device, so that the safety device is moved into the protective position as a consequence of the spring force.

Various parameters, which can be taken into account individually or in combination, may be considered as status parameters of the microtome, on which the adjustment of the safety device into the protective position depends.

Provisions are made in a first possible embodiment of the present invention for detecting the relative motion between the specimen holder and the knife by means of the sensor. The knife is usually designed as a stationary knife, while the specimen holder performs an alternating to-and-fro motion, which is superimposed in its end areas by an additional feeding or retracting motion extending at right angles thereto. Monitoring is performed according to the present invention to determine whether a relative motion occurs during a predetermined time period between the specimen holder and the knife. If no relative motion is determined within the predetermined time period, it is assumed that the processing of the specimen has been completed or at least interrupted, and the driving device, which brings the safety device into the protective position, is activated.

Provisions may be made in another embodiment of the present invention for the position of the specimen holder to be able to be detected by means of the sensor. When the user moves the specimen holder into a predetermined position, in which the specimen holder is usually at the greatest distance possible from the knife in order to have sufficient space for replacing the specimen, the approach to this predetermined position can be detected. As soon as it is determined that the specimen holder reaches the predetermined position, the control device activates the driving device of the safety device and adjusts this into the protective position.

When the specimen holder is moved to and fro for the cutting operation, this may take place either by means of a crank, which can be actuated manually, or by means of an electric motor. Provisions may be made now for the sensor to detect the operating parameters of the electric motor. When it is determined that the electric motor is stopped and the specimen holder is not consequently being driven, the control device activates the driving device of the safety device, as a result of which this is adjusted into the protective position.

The motion of the crank handle may also be detected in the same manner, and an adjustment of the safety device into the protective position takes place when the crank handle is stopped.

To hold the specimen holder securely during the replacement of the specimen, a fixing device, for example, in the form of a brake or a locking mechanism, by means of which the specimen holder can be fixed in a predetermined position, may be associated with the specimen holder in a variant of the present invention. The operating state of the fixing device can be detected by means of the sensor. When it is determined that the specimen holder is fixed, the driving device is activated in the above-mentioned manner and it adjusts the safety device into the protective position.

After replacement of the specimen, the safety device must be reset again from the protective position into the release position. This may be brought about manually, for example, under simultaneous preloading of said spring, but provisions are preferably made for the safety device to be able to be brought from the protective position into the release position by means of the driving device. This is also necessary when the knife shall be replaced.

The above-mentioned object is accomplished with respect to the method by status parameters of the microtome being detected and analyzed and by the safety device being brought into a protective position, in which it covers the knife at least partially, as a function of the status parameters.

Further features and design possibilities of the method appear from the description given above and below, to which reference is made in order to avoid repetitions.

Further details and features of the present invention appear from the following description of exemplary embodiments with reference to the drawings.

The present invention shall be explained in more detail on the basis of the following figures and exemplary embodiments, without the present invention being limited to these. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of essential parts of a microtome with a safety device in the release position;

FIG. 2 is the microtome according to FIG. 1 with the safety device in the protective position;

FIG. 3 is a view of a variant of the microtome according to FIG. 1 with the safety device in the release position; and

FIG. 4 is the microtome according to FIG. 3 with the safety device in the protective position.

### DESCRIPTION OF THE PREFERRED EMBODIMENTS

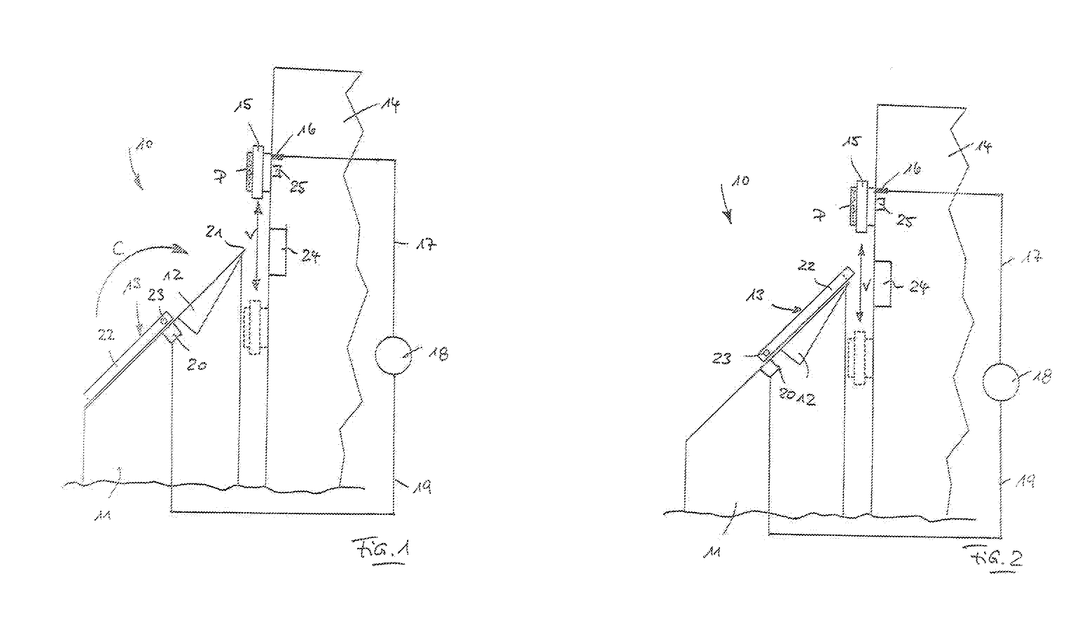

Referring to the drawings, FIG. 1 shows a microtome 10 in a schematic view with a knife holder 11, to which a knife 12, which has a blade 21, is fixed. Furthermore, a safety device 13 in the form of a strap 22, which is pivotable about a pivot bearing 23, is arranged at the knife holder 11, and the pivoting motion indicated by the arrow C is brought about by a driving device 20. The strap 22 can be moved from the release position shown in FIG. 1, in which it is arranged next to or under the knife 12, into the protective position shown in FIG. 2, in which the strap 22 covers the blade 21 of the knife 12.

On its side facing the knife 12, a housing 14 carries a specimen holder 15, which can be moved vertically to and fro by means of a driving device 24, for example, an electric motor, as this is indicated by the double arrow V. A tissue specimen P is arranged at the specimen holder 15. The specimen holder 15 is shown in FIG. 1 in an upper end position, from which it can be moved into a lower end position indicated by broken line. The knife 12 shaves off a thick slice, which will be subjected to further processing, from the specimen P during this motion.

A fixing device 25, with which the specimen holder 15 can be fixed in its end position, is provided for the specimen holder 15 in the upper end position.

A sensor 16, with which it can be determined whether the specimen holder 15 is located in the upper end position and whether it is stopped in this end position or is fixed by means of the fixing device 25, is arranged close to the upper end position of the specimen holder 15.

The sensor shown in FIG. 1 represents a possible exemplary embodiment only for detecting an operating state or status parameter of the microtome 10. As an alternative, or in addition, other sensors may also be provided for detecting other status parameters, as they were already described above.

The sensor 16 is in connection via a line 17 with a control device 18 or an analyzing unit, which is connected via a line 19 with the driving device 20 of the safety device 13. When it is determined by means of the sensor 16 that the specimen holder 15 is stopped in the upper end position for at least a predetermined time period, the driving device 20 is activated by the control device 18 via the line 19, as a result of which the safety device 13 pivots from the release position shown in FIG. 1 into the protective position shown in FIG. 2 as this is indicated by arrow C. The user can replace the specimen P in this position without there being a risk of injury at the knife 12.

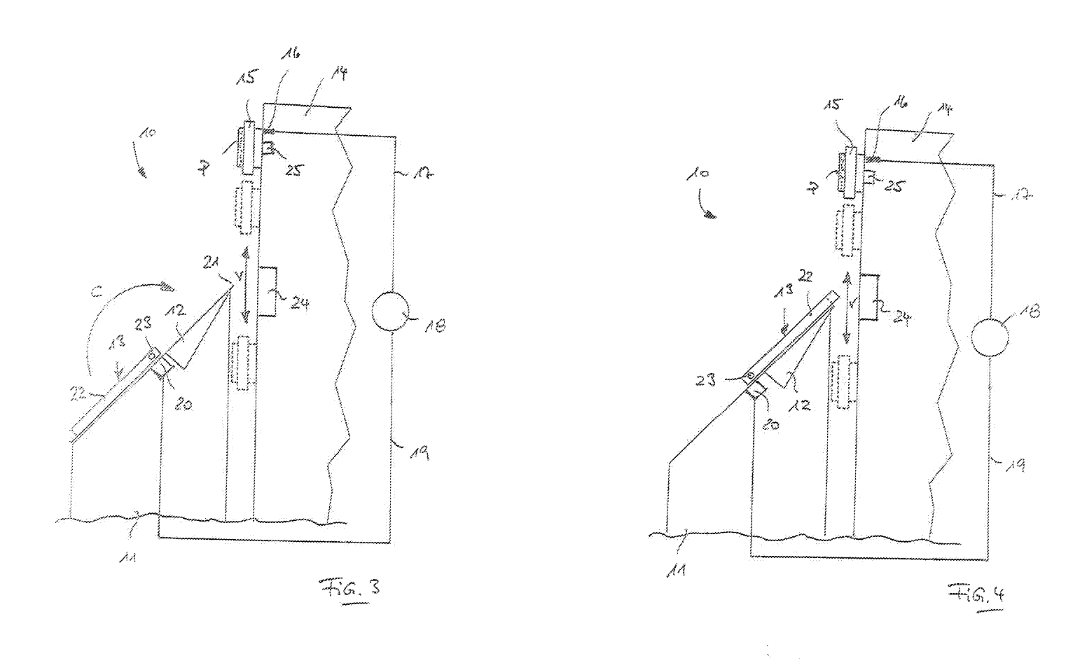

The exemplary embodiment shown in FIGS. 3 and 4 is very similar to the exemplary embodiment according to FIGS. 1 and 2 and differs from this only in that the specimen holder 15 can be adjusted from its upper end position, which it reaches during the operation during which the specimen P is cut, into a replacement position, which is located above it according to FIG. 1 and even farther away from the knife 12, and which is indicated by solid lines in FIGS. 3 and 4. It is detected by means of the sensor 16 that the specimen holder 15 has reached the replacement position and remains in this position, after which the safety device 13 is activated in the above-mentioned manner and is brought into the protective position, in which it covers the knife 12, as this is shown in FIG. 4.

As soon as the tissue specimen P has been replaced, the user can pivot back the strap 22 of the safety device 13 either manually from the protective position into the release position, or the driving device 20 is correspondingly activated and pivots the strap 22 into the release position, after which thin sections can be shaved off from the new specimen.

While specific embodiments of the invention have been shown and described in detail to illustrate the application of the principles of the invention, it will be understood that the invention may be embodied otherwise without departing from such principles.

1. A microtome comprising:
a knife and with
a specimen holder for a specimen, wherein the specimen holder is adjustable relative to the knife;
a safety device for the knife, which safety device is adjustable between a protective position, in which the safety device covers the knife at least partially, and a release position, in which the safety device releases the knife;
a driving device, by means of which the safety device can be brought at least from the release position into the protective position, associated with the safety device;
a sensor detecting status parameters of the microtome; and
a control device with which the status parameters are analyzed wherein the driving device can be actuated by the control device as a function of at least one status parameter of the status parameters of the microtome, wherein relative motion between the specimen holder and the knife and/or the position of the specimen holder can be detected by means of the sensor.

2. A microtome in accordance with claim 1, wherein the safety device comprises a strap, which can be placed over a blade of the knife.

3. A microtome in accordance with claim 2, wherein the strap is pivotable.

4. A microtome in accordance with claim 1, wherein the driving device comprises an electric motor, an electromagnetic drive or a spring.

5. A microtome in accordance with claim 1, further comprising a specimen holder driving device wherein the specimen holder driving device comprises an electric motor and the specimen holder is driven by means of the electric motor and that the operating state of the electric motor can be detected by means of the sensor.

6. A microtome in accordance with claim 1, further comprising a fixing device, by means of which the specimen holder can be fixed in a predetermined position, associated with the specimen holder, and the operating state of the fixing device can be detected by means of the sensor.

7. A microtome in accordance with claim 1, wherein the safety device can be brought from the protective position into the release position by means of the driving device.

8. A method for controlling a safety device of a knife of a microtome the method comprising the steps of:
providing the microtome with the knife with a specimen holder for a specimen, wherein the specimen holder is adjustable relative to the knife and with the safety device for the knife adjustable between a protective position, in which the safety device covers the knife at least partially, and a release position, in which the safety device releases the knife and with a driving device, by means of which the safety device can be brought at least from the release position into the protective position, associated with the safety device and with at least one sensor detecting status parameters of the microtome and with a control device with which the status parameters are analyzed and wherein the driving device can be actuated by the control device as a function of at least one status parameter of the status parameters of the microtome, wherein relative motion between the specimen holder and the knife and/or the position of the specimen holder can be detected by means of the sensor;
detecting status parameters of the microtome by means of the at least one sensor
analyzing status parameters with the control device, wherein a monitoring is performed to determine whether a relative motion takes place between the specimen holder and the knife during a predetermined time period and/or whether the specimen holder is in a predetermined position for replacing the specimen; and
bringing the safety device by means of the driving device into a protective position, in which the safety device covers the knife at least partially, as a function of the status parameters.

9. A method in accordance with claim 8, wherein the safety device comprises a strap, which can be placed over a blade of the knife.

10. A method in accordance with claim 9, wherein the strap is pivotably mounted for pivotal movement to the and the protective position.

11. A method in accordance with claim 8, wherein the driving device comprises one of an electric motor, an electromagnetic drive and a spring.

12. A method in accordance with claim 8, further comprising a specimen holder driving device wherein the specimen holder driving device comprises an electric motor and the specimen holder is driven by means of the electric motor and that the operating state of the electric motor can be detected by means of the at least one sensor.

13. A microtome in accordance with claim 1, further comprising a fixing device, by means of which the specimen holder can be fixed in a predetermined position, associated with the specimen holder, and the operating state of the fixing device can be detected by means of the sensor.

14. A microtome in accordance with claim 1, wherein the safety device can be brought from the protective position into the release position by means of the driving device.
